(19) United States
(12) Patent Application Publication
(10) Pub. No.: US 2026/0147581 A1
(43) Pub. Date: May 28, 2026

(54) LOW LATENCY LOADING OF BASIC INPUT/OUTPUT SYSTEM (BIOS) FIRMWARE

(71) Applicant: ADVANCED MICRO DEVICES, INC., Santa Clara, CA (US)

(72) Inventors: Hsiu-Ming Chu Simon, Taipei (TW); Chih-Chieh Lin, Taipei (TW); Cheng-Ju Tsai, Taipei (TW)

(21) Appl. No.: 18/960,099

(22) Filed: Nov. 26, 2024

(51) Int. Cl. G06F 9/4401; G06F 9/38

(52) U.S. Cl. CPC G06F 9/4401; G06F 9/38

(57) ABSTRACT

An apparatus, such as a system-on-a-chip (SoC), includes a first processing unit configured to fetch a first subset of firmware from a first memory to a second memory in response to the apparatus being powered up. The apparatus also includes a second processing unit configured to execute the first subset of the firmware from the second memory. The first processing unit is configured to fetch a second subset of the firmware from the first memory to the second memory concurrently with the second processing unit executing the first subset. In some cases, the firmware includes Basic Input/Output System (BIOS) firmware or unified extensible firmware interface (UEFI) firmware. In some cases, the first memory is a nonvolatile flash memory that operates according to a serial peripheral interface (SPI) protocol for synchronous serial communication and apparatus includes an SPI interface.

### BACKGROUND

The central processing unit (CPU) of a processing system, such as a system-on-a-chip (SoC), executes software or firmware stored in a local memory. The local memory can be implemented as a static random-access memory (SRAM) or dynamic random-access memory (DRAM). However, the CPU’s memory does not retain installed executable code (such as software or firmware) when the CPU is powered down. Thus, the CPU must load executable code into its local memory from another memory to initiate the boot process in response to a user powering up the processing system. As such, the CPU typically is configured to access this executable code from an external location. For example, the CPU can be configured to fetch Basic Input/Output System (BIOS) or unified extensible firmware interface (UEFI) firmware from an external memory to its local memory. This firmware initializes hardware components in the processing system and then performs a Power-On Self Test (POST) to confirm that the system is operating correctly. If the POST is successful, additional software or firmware, such as a boot loader program, is executed to load an operating system (OS) onto the CPU. The boot process fails if the POST is unsuccessful.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 illustrates a processing system that provides low latency loading of firmware in response to powering up, according to some embodiments.

FIG. 2 illustrates a method of loading subsets of firmware concurrently with executing previously loaded subsets during boot up of a processing system, according to some embodiments.

FIG. 3 illustrates a method of determining whether to load subsets of firmware concurrently with executing previously loaded subsets during boot up of a processing system, according to some embodiments.

### DETAILED DESCRIPTION

Processing systems include (or have access to) stable, nonvolatile memory that stores firmware and non-volatile data used during initialization, such as BIOS/UEFI code, boot loaders, early platform code, and silicon initialization code. In some cases, the stable, nonvolatile memory is implemented as flash memory that supports relatively fast random-access read times using an architecture based on NOR (not-OR) gates. The flash memory typically operates according to a serial peripheral interface (SPI) protocol for synchronous serial communication between devices. For example, the BIOS/UEFI code can be stored in a flash memory configured as read-only memory (ROM) that is accessed via a bus and/or interface according to the SPI protocol. A typical SPI ROM is relatively small (e.g., 32 megabytes, MB) so an image of the BIOS/UEFI firmware is compressed to fit on the SPI ROM. In response to powering up, a conventional processing system loads the compressed image from the SPI ROM to the local memory over a relatively slow SPI bus and then decompresses the loaded, compressed image before executing the firmware from the local memory. This process incurs relatively significant latency due to the relatively slow rate of transfer over the SPI bus and the subsequent decompression process for the compressed firmware. For example, the boot process for a conventional processing system can be on the order of a seconds or even tens of seconds.

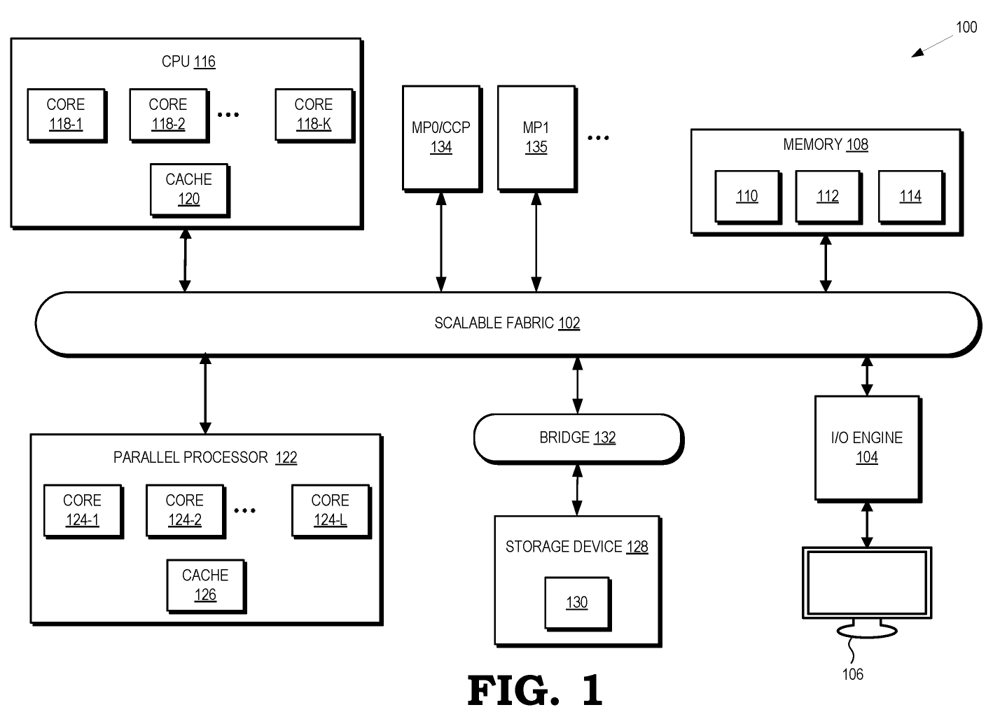

FIGS. 1-3 describe apparatuses, systems, and methods for reducing the latency of fetching firmware from a nonvolatile flash memory during initialization (e.g., boot up) of a processing system. A processing unit (such as a coprocessor) fetches a first subset of firmware from the nonvolatile flash memory to a local memory of a CPU in the processing system. The firmware can be an image of, for example, BIOS/UEFI firmware and the image can be compressed. The processing unit can also decompress and authenticate the first subset of the firmware. A microcontroller and/or a core of the CPU executes the first subset of the firmware concurrently with the processing unit fetching (and, if appropriate, decompressing and authenticating) a second subset of the firmware from the nonvolatile flash memory to the local memory. In some cases, the processing unit subsequently fetches (and, if appropriate, decompressing and authenticating) additional subsets of the firmware from the nonvolatile flash memory to the local memory concurrently with the microcontroller and/or the core executing one or more previously fetched, decompressed, and authenticated subsets of the firmware.

Some embodiments of the processing unit compare the size of the (decompressed, if appropriate) firmware to the available space in the local memory. If the firmware size is smaller than the available space, the processing unit fetches the firmware from the nonvolatile flash memory to the local memory. If the firmware size is larger than the available space, the processing unit fetches subsets of the firmware from the nonvolatile flash memory concurrently with the microcontroller and/or the core executing previously fetched subsets of the firmware. In some cases, the processing system is a system-on-a-chip (SOC) that includes the CPU, the microprocessor, the processing unit (e.g., a coprocessor), and the local memory. The local memory can be implemented as SRAM. Fetching subsets of the firmware image concurrently with executing previously fetched subsets of the firmware image can significantly reduce latency during initialization processes including boot up of the processing system. For example, the latency can be reduced from a few seconds to about 500 milliseconds (ms).

FIG. 1 illustrates a processing system 100 that provides low latency loading of firmware in response to powering up, according to some embodiments. The processing system 100 includes a scalable fabric 102 implemented with circuitry that supports communication between entities implemented in the processing system 100. The scalable fabric 102 can include a control fabric for conveying control signals and a data fabric for conveying data between entities in the processing system 100. Some implementations of the processing system 100 include other buses, bridges, switches, routers, and the like, which are not shown in FIG. 1 in the interest of clarity. An input/output (I/O) engine 104 is implemented with circuitry that handles input or output operations associated with a display 106, as well as other elements of the processing system 100 such as keyboards, mice, printers, external disks, and the like. The I/O engine 104 is coupled to the scalable fabric 102 so that the I/O engine 104 can communicate with other entities in the processing system 100 by exchanging signals over the scalable fabric 102.

Processing system 100 also includes or has access to a memory 108 or other storage component(s) implemented using a non-transitory computer-readable medium such as a dynamic random-access memory (DRAM). However, some embodiments of the memory 108 are implemented using other types of memory including, for example, static random-access memory (SRAM), nonvolatile RAM, and the like. Some embodiments of the memory 108 store information representing instructions such as program code 110 for one or more applications (e.g., graphics applications, compute applications, machine-learning applications), data 112 that is consumed by the program code 110, and results 114 produced by executing the program code 110.

A central processing unit (CPU) 116 is connected to the scalable fabric 102 to communicate with other entities in the processing system 100, such as the memory 108. The CPU 116 implements circuitry such as a plurality of processor cores 118-1..K that execute instructions concurrently or in parallel. In some embodiments, one or more of the processor cores 118 operate as single-instruction-multiple-data (SIMD) units that perform the same operation on different data sets concurrently or in parallel. The CPU 116 is configured to execute instructions such as the program code 110 for one or more applications. Examples of applications include memory management applications, graphics applications, compute applications, and machine-learning applications. The CPU 116 can consume data 112 and store information in the memory 108 such as the results 114 of the executed instructions. The CPU 116 also includes local memory such as one or more caches 120. In the illustrated embodiment, the one or more caches 120 are implemented using SRAM, although other types of memory can be used in other embodiments. The caches 120 can include L1, L2, or L3 caches.

Some embodiments of the processing system 100 include a parallel processor 122. The parallel processor 122 can include, for example, a graphics processing unit (GPU), a general-purpose GPU (GPGPU), a neural processing unit (NPU), an intelligence processing unit (IPU), or another vector processor or parallel processor. The parallel processor 122 includes circuitry to implement one or more processor cores 124-1..L that each operate as a compute unit configured to perform one or more operations based on one or more instructions received by the parallel processor 122. Although three processor cores 124 are shown in FIG. 1, more or fewer processor cores 124 can be implemented in other embodiments of the parallel processor 122. The compute units in the processor cores 124 are implemented as circuitry for one or more single-instruction, multiple data (SIMD) units that perform the same operation on different data sets to produce one or more results. The parallel processor 122 also includes local memory such as one or more caches 126 that can be implemented with SRAM or other circuitry. The caches 126 can include L1, L2, or L3 caches.

A storage device 128 is used to store information used by entities in the processing system including the CPU 116 or the parallel processor 122. In the illustrated embodiment, the storage device 128 is implemented as SPI storage that includes one or more nonvolatile memory components that can be accessed randomly and/or one or more memory components that are accessed in serial. For example, NOR-based circuitry can be used to implement memory components that are accessed randomly, and NAND-based circuitry can be used to implement memory components that are accessed in serial. As discussed herein, the storage device 128 includes or is connected to one or more controllers that support a common interface (such as an SPI interface) between the different types of memory components and other entities in the processing system 100. The storage device 128 stores firmware 130 that is executed in response to a user powering up the processing system 100 or other triggers such as initialization of portions of the processing system 100. In some embodiments, the firmware 130 includes Basic Input/Output System (BIOS) firmware and/or unified extensible firmware interface (UEFI) firmware. The firmware 130 (or portions thereof) can be stored in compressed form, in which case it is appropriate to decompress the firmware 130 before execution.

Some embodiments of the processing system 100 include a bridge 132 that is connected to the scalable fabric 102 to communicate with other entities in the processing system 100, such as the CPU 116 or the parallel processor 122. The bridge 132 can include (or be connected to) an SPI interface that conveys information to devices that operate according to the SPI protocol, such as the storage device 128. Some embodiments of the bridge 132 are implemented as a peripheral component interface (PCI) bridge or a PCI express (PCI-e) bridge. In the illustrated embodiment, the storage device 128 communicates with other entities in the processing system via the bridge 132. However, some embodiments of the storage device 128 can communicate using other bridges, buses, interfaces, or combinations thereof.

The processing system 100 includes one or more microprocessors (generally referred to as processing units) such as the microprocessor 134 and the microprocessor 135. In the illustrated embodiment, the microprocessor 134 includes circuitry configured to implement a cryptographic coprocessor (CCP), which can be implemented as a part of a platform security processor (PSP). The CCP on the microprocessor 134 performs hardware-accelerated cryptography and can function as a direct memory access (DMA) copy engine for performing mass copy operations including loading and decompressing firmware. The microprocessors 134 and 135 include circuitry configured to execute firmware in response to the processing system 100 being initialized or powered up. In the illustrated embodiment, the microprocessor 134 is configured to fetch subsets of the firmware 130 from the storage device 128 in response to powering up the processing system 100, e.g., as part of an initialization or boot up process. For example, the CCP implemented by the microprocessor 134 can fetch an image of BIOS firmware 130 from the storage device 128 via an SPI interface. Fetching subsets of the firmware 130 includes reading the firmware 130 from the storage device 128 and writing or copying the firmware 130 another memory such as the memory 108 or one or more of the caches 120, 126.

One or more other processing units in the processing system 100 are configured to execute fetched portions or subsets of the firmware 130 concurrently with the microprocessor 134 (or other processing unit) fetching other portions or subsets of the firmware 130. In some embodiments, the microprocessor 135 is configured to execute previously fetched subsets of the firmware 130 from local memory that includes the previously fetched subsets such as the memory 108 or one or more of the caches 120, 126. In other embodiments, one or more of the processor cores 118 in the CPU 116 or the processor cores 124 in the parallel processor 122 are configured to execute the previously fetched subsets of the firmware 130. The microprocessor 134 is further configured to fetch one or more additional subsets of the firmware 130 from the storage device 128 to the local memory (e.g. the memory 108 or the caches 120, 126) concurrently with one or more other processing units executing some or all the previously fetched subsets of the firmware 130.

In some embodiments, multiple entities in the processing system 100 are implemented on a common substrate that can be referred to as a system-on-a-chip (SoC). For example, the scalable fabric 102, the CPU 116, the parallel processor 122, and the microprocessors 134, 135 can be implemented on a common substrate to form an SoC. One or more of the I/O engine 104, the memory 108, and the bridge 132 can also be implemented on some embodiments of the SoC. Entities that are implemented on the common substrate are referred to herein as “internal” to the SoC and entities that are not implemented on the common substrate are referred to herein as “external” to the SoC. For example, the memory 108 can be referred to as an internal memory if it is implemented on the common substrate or the memory 108 can be referred to as an external memory if it is not implemented on the common substrate.

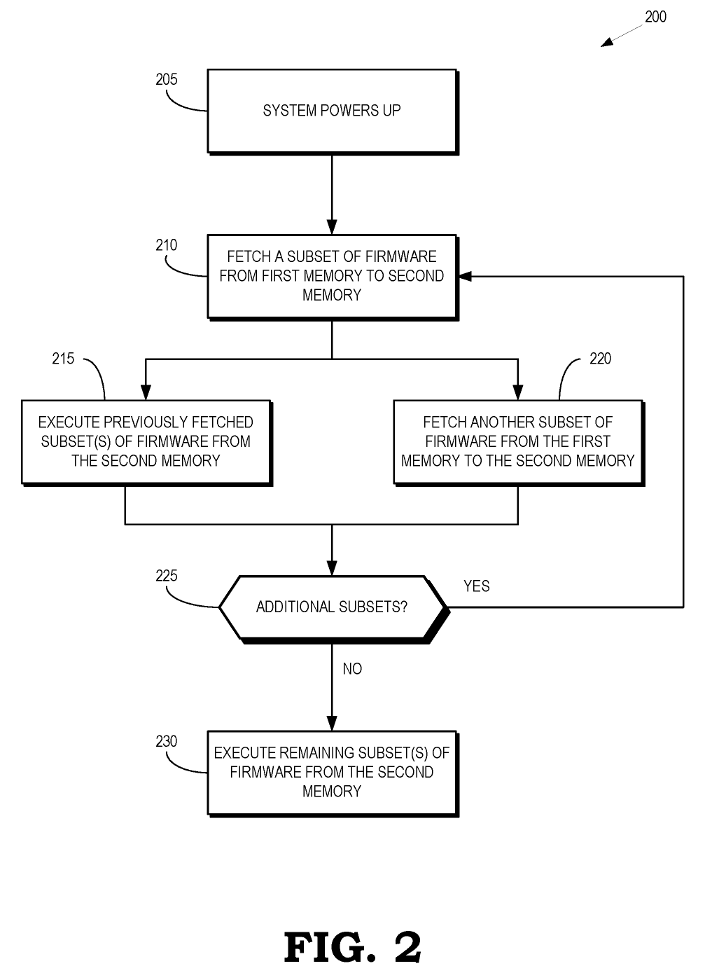

FIG. 2 illustrates a method 200 of loading subsets of firmware concurrently with executing previously loaded subsets during boot up of a processing system, according to some embodiments. The method 200 is implemented in some embodiments of the processing system 100 shown in FIG. 1.

At block 205, the processing system is initialized or powers up. For example, the processing system can power up in response to a user powering up or restarting a processing system such as the processing system 100 shown in FIG. 1.

At block 210, a first processing unit in the processing system that is a subset of firmware from a first memory into a second memory. In some embodiments, the first processing unit is a microprocessor or a CCP implemented in the microprocessor. Initially, the microprocessor (or CCP) fetches a first subset of the firmware from the first memory, which can be an external memory such as an SPI storage device. The microprocessor (or CCP) then writes or stores the first subset in a second memory such as an internal memory or cache in an SoC. For example, the microprocessor 134 can fetch a subset of the firmware from the storage device 128 to the memory 108 or the cache 120 shown in FIG. 1. If the first subset of the firmware is stored in compressed form, the first processing unit can decompress the first subset before writing it to the second memory. Some embodiments of the first processing unit are also configured to authenticate information in the first subset, e.g., using cryptographic keys or hashes. The method 200 then flows to the blocks 215 and 220, which are performed concurrently.

At block 215, a second processing unit in the processing system executes one or more previously fetched subsets of the firmware from the second memory. For example, the microprocessor 135 or one or more of the cores 118 can execute the previously fetched subset(s) of the firmware from the memory 108 or the cache 120 shown in FIG. 1.

At block 220, the first processing unit fetches another subset of the firmware from the first memory to the second memory. For example, the microprocessor 134 can fetch another (previously unfetched) subset of the firmware from the storage device 128 to the memory 108 or the cache 120 shown in FIG. 1. If appropriate, e.g., if the other subset of the firmware is stored in compressed form, the first processing unit decompresses and/or authenticates the information in the other subset of the firmware. Fetching the subsequent subset of the firmware (at block 220) concurrently with the second processing unit executing (at block 215) previously fetched subsets significantly reduces the time that he lapses during boot up of the processing system. The method then flows to the block 225.

At block 225, the first processing unit determines whether there are additional subsets of the firmware that have not yet been fetched from the first memory to the second memory. If so, the method 200 flows to the block 210 and another subset is fetched and, if appropriate, decompressed or authenticated. If no additional subsets of the firmware remain to be fetched, the method 200 flows to block 230.

At block 230, the second processing unit executes any remaining (i.e., unexecuted) subsets of the firmware from the second memory.

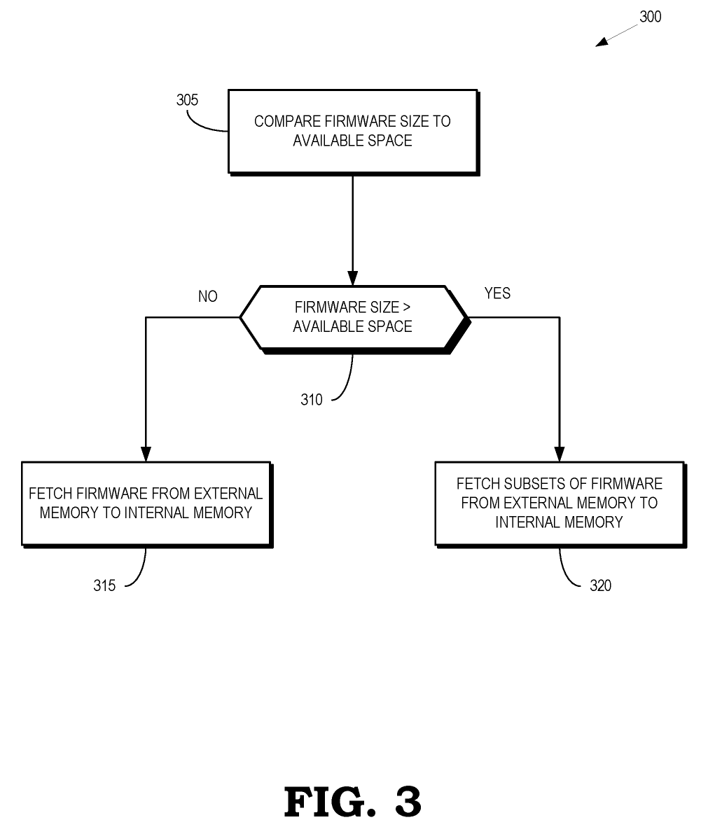

FIG. 3 illustrates a method 300 of determining whether to load subsets of firmware concurrently with executing previously loaded subsets during boot up of a processing system, according to some embodiments. The method 300 is implemented in some embodiments of the processing system 100 shown in FIG. 1.

At block 305, a first processing unit compares a size of firmware that is to be fetched from a first (external) memory to the available space in a second (internal) memory associated with a second processor. For example, the microprocessor 134 can compare the size of the firmware 130 to the space available in the cache 120 shown in FIG. 1. If the firmware is stored in a compressed format in the first memory, the first processing unit compares a size of the decompressed firmware to the available space.

At block 310, the first processing unit determines whether the size of the firmware (or decompressed firmware) is greater than the available space in the internal memory. If so, and a full image of the firmware can be loaded into the internal memory, the method 300 flows to the block 315. If not, and a full image of the firmware cannot be loaded into the internal memory, the method 300 flows to the block 320.

At block 315, the first processing unit fetches an image of the firmware from the external memory to the internal memory. As discussed herein, fetching the image of the firmware can include decompressing and/or authenticating the firmware. The second processing unit can then execute the firmware from the internal memory.

At block 320, the first processing unit fetches subsets of the firmware from the external memory to the internal memory. As discussed herein, the second processing unit executes previously fetched subsets of the firmware from the internal memory concurrently with the first processing unit fetching additional subsets of the firmware from the external memory to the internal memory.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the embodiments disclosed above may be altered or modified and all such variations are considered within the scope of the disclosed subject matter. Accordingly, the protection sought herein is set forth in the claims below.

What is claimed is:

1. An apparatus comprising:
a first processing unit configured to fetch a first subset of firmware from a first memory to a second memory in response to the apparatus being initialized; and
a second processing unit configured to execute the first subset of the firmware from the second memory,
the first processing unit being configured to fetch a second subset of the firmware from the first memory to the second memory concurrently with the second processing unit executing the first subset.

2. The apparatus of claim 1, wherein the firmware comprises at least one of Basic Input/Output System (BIOS) firmware or unified extensible firmware interface (UEFI) firmware.

3. The apparatus of claim 1, wherein the first memory is external to the apparatus and the second memory is internal to the apparatus.

4. The apparatus of claim 3, wherein the first memory comprises nonvolatile flash memory that operates according to a serial peripheral interface (SPI) protocol for synchronous serial communication; and further comprising:
an SPI interface that conveys information from the first memory to the second memory.

5. The apparatus of claim 3, wherein the second memory comprises at least one of a static random-access memory (SRAM) or dynamic random-access memory (DRAM).

6. The apparatus of claim 1, wherein:
the first subset of the firmware is stored in compressed form in the first memory;
the second subset of the firmware is stored in compressed form in the first memory; and
the first processing unit is further configured to:
decompress the compressed form of the first subset of the firmware before storing the first subset in the second memory; and
decompress the compressed form of the second subset of the firmware before storing the second subset in the second memory.

7. The apparatus of claim 6, wherein the first processing unit is configured to compare a size of decompressed firmware to available space in the second memory.

8. The apparatus of claim 7, wherein the first processing unit is configured to fetch the firmware from the first memory to the second memory in response to the size of the decompressed firmware being smaller than the available space in the second memory and to fetch at least one subset of the firmware from the first memory to the second memory in response to the size of the decompressed firmware being larger than the available space in the second memory.

9. The apparatus of claim 6, wherein the first processing unit is configured to authenticate at least one of the first subset and the second subset of the firmware.

10. A method, comprising:
fetching, using a first processing unit a first subset of firmware from a first memory to a second memory in response to the first processing unit being initialized;
executing, on a second processing unit, the first subset of the firmware from the second memory; and
fetching, using the first processing unit, a second subset of the firmware from the first memory to the second memory concurrently with the second processing unit executing the first subset.

11. The method of claim 10, wherein fetching the first subset or the second subset of the firmware comprises fetching at least one of Basic Input/Output System (BIOS) firmware or unified extensible firmware interface (UEFI) firmware.

12. The method of claim 10, wherein fetching the first subset or the second subset of the firmware from the first memory comprises fetching the first subset or the second subset from a nonvolatile flash memory that operates according to a serial peripheral interface (SPI) protocol for synchronous serial communication.

13. The method of claim 10, the first subset of the firmware is stored in compressed form in the first memory and the second subset of the firmware is stored in compressed form in the first memory; and further comprising:
decompressing, using the first processing unit, the first subset of the firmware before storing the first subset in the second memory; and
decompressing, using the first processing unit, the second subset of the firmware before storing the second subset in the second memory.

14. The method of claim 13, further comprising:
comparing, using the first processing unit, a size of decompressed firmware to available space in the second memory.

15. The method of claim 14, further comprising:
fetching the firmware from the first memory to the second memory in response to the size of the decompressed firmware being smaller than the available space in the second memory; and
fetching at least one subset of the firmware from the first memory to the second memory in response to the size of the decompressed firmware being larger than the available space in the second memory.

16. The method of claim 10, further comprising:
authenticating at least one of the first subset and the second subset of the firmware.

17. A system-on-a-chip (SoC), comprising:
a first memory;
a processing unit configured to execute code from the first memory; and
a coprocessor configured to fetch a first subset of firmware from a second memory to the first memory in response to the SoC being initialized and to fetch a second subset of the firmware from the second memory to the first memory concurrently with the processing unit executing the first subset.

18. The SoC of claim 17, wherein the processing unit comprises at least one of a microcontroller or a core of a central processing unit (CPU).

19. The SoC of claim 17, wherein the second memory comprises nonvolatile flash memory that operates according to a serial peripheral interface (SPI) protocol for synchronous serial communication; and further comprising:
an SPI interface that conveys information between the first memory and the second memory.

20. The SoC of claim 17, wherein the first memory comprises at least one of a static random-access memory (SRAM) or dynamic random-access memory (DRAM).
